(19) United States
(12) Patent Application Publication
(10) Pub. No.: US 2007/0244826 A1
(43) Pub. Date: Oct. 18, 2007

(54) Method of managing and auditing intellectual property

(76) Inventor: Jung-Bang Wang, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/478,725

(22) Filed: Jul. 3, 2006

(30) Foreign Application Priority Data
Apr. 18, 2006 (TW) 95113845

(51) Int. Cl. H04L 9/00

(52) U.S. Cl. 705/59

(57) ABSTRACT

A method of managing and auditing intellectual property for judging whether relevant software is true or counterfeit by using a product activation unit to judge a pairing of a hardware number and a license and royalty number set. Moreover, when the same software is installed in different hardware systems, the product activation unit can automatically renew product number. Hence, the method avoids user's complain such as the user must access an Internet site or make a phone call for anew applying another product number. Moreover, the method allows searching and collection of information over the Internet via IP by an ISP. Therefore, it is not necessary to resort to legal avenues, such as a physical search of a property which gives counterfeit software users a chance to wipe hard drives before evidence has been collected, to enforce the copyright holder's rights on software that is being used without permission.

### BACKGROUND OF THE INVENTION

1. Field of the Invention

The present invention relates to a method of managing and auditing intellectual property, and particularly relates to a method for judging whether relevant software is true or counterfeit by using a product activation unit to judge a pairing of a hardware number (HWN) and a license and royalty number set (Ln+Rn set).

2. Description of the Related Art

To be properly licensed a product needs to meet two conditions (1) the corresponding product has been licensed to allow manufacturing, and (2) a licensee has paid royalty fees for the product. However, under the lure of benefit, a lot of illegal manufacturers produce many products that encroach upon the legal rights of a patent holder. Also, some manufacturers that have obtained a license to manufacture a product utilize the license to cover up illegal behavior and evade paying royalty fees to the rights holder. These encroachments upon licensed products have made the normal market circulation of commodities suffer greatly, especially licensees that have spent a large amount of manpower and financial resources in creating a fine brand. Moreover, because of the progress and development of science and technology, counterfeiters can often easily produce something that is faked but looks like the genuine article. Hence, a lot of anti-falsification technology is actually useless in identifying whether an article is genuine or not.

In order to solve the problem of products being counterfeited, it is important to improve anti-falsification technology. Many kinds of anti-counterfeit tags have already been disclosed in prior art, such as laser holographs, fluorescent ink, or variable ink, etc. However, the greatest problem of current anti-falsification technology is that if consumers want to distinguish between genuine and fake goods, they must rely on a corresponding piece of equipment or tool to help them make that distinction. As stated, with the development of science and technology, counterfeiters can make anti-counterfeit tags that are faked, but look genuine. Therefore, it is difficult to stop imitations and encroachment upon licensed products.

Concerning the counterfeiting of software, normal anti-counterfeit tags cannot be used to prevent the pirating of products. Hence, some factory owners have started to use anti-pirating technology—MPA (Microsoft product Activation) for preventing counterfeit market software from being used. The key feature of MPA is when an OS (Operation System) or application software is installed on a hard disk, an EULA (End User License Agreement) of the OS or the application software can be opened at some stage and the OS or the application software can be licensed via a pairing of a COA (Certificate of Authenticity) that is attached to the OS or the application software, and a hardware ID (HID).

FIG. 1 shows a flow chart of a method of managing and auditing intellectual property according to a prior art. The known method comprises: opening the EULA (End User License Agreement) of the OS (S100); transmitting a product key (PK) of the COA and the HID to a product activation unit (S102); and then judging whether the PK is true via the product activation unit (S104). If the PK is not true, the OS is counterfeit, so that a user cannot use the OS or can only use the OS's trial edition (trial edition means software that is just a simplified version of the software, and/or only allows use of the software for a limited time).

Moreover, in the step S104, if the PK is true, judging whether a pairing of the PK and the HID (PK+HID) has not been used yet (S106). If the pairing of the PK and the HID (PK+HID) has not been used yet, the pairing of the PK and the HID (PK+HID) is true (S108); downloading a product number (PN) composed of the pairing of the PK and the HID (PK+HID), from the product activation unit (S110); and then installing the PN in the EULA for licensing the OS to be used in the hardware device (S112).

However, in the step S106, if the pairing of the PK and the HID (PK+HID) has been used one time, it means that the OS has been installed in another hard disk and under another HID before. Hence, the user needs to Internet access or make a phone call for anew applying another product number (another PN) (S114), and then executing the step S110. Moreover, if both the pairing of the PK and the HID (PK+HID) and the pairing of the PK and the another HID (PK+another HID) have existed one time, it means that the OS has been installed two times on two different hard disks and under two different HIDs, so that the OS is counterfeit, and the user cannot use the OS or can only use the OS's trial edition (S116).

### SUMMARY OF THE INVENTION

The present invention provides a method of managing and auditing intellectual property. The method can judge whether relevant software is true or counterfeit by using a product activation unit to judge a pairing of a hardware number (HWN) and a license and royalty number set (Ln+Rn set). Moreover, when the same software is installed in different hardware systems, the product activation unit can automatically renew product number. Hence, the method avoids user's complain such as the user must access an Internet site or make a phone call for anew applying another product number. Moreover, the method allows searching and collection of information over the Internet via IP by an ISP (Internet Service Provider). Therefore, it is not necessary to resort to legal avenues, such as a physical search of a property which gives counterfeit software users a chance to wipe hard drives before evidence has been collected, to enforce the copyright holder's rights on software that is being used without permission.

One aspect of the present invention is method of managing and auditing intellectual property. The method comprises: (a) providing a first license and royalty number set (first Ln+Rn set) that corresponds to a hardware number (HWN) of a hardware device from a product licensed unit; (b) executing an OS (Operating System) installed in the hardware device for opening an EULA (End User License Agreement) of the OS; and, (c) transmitting the first Ln+Rn set, the hardware device's IP, and the HWN to a product activation unit.

Moreover, the method further comprises: (d) judging whether the first Ln+Rn set has been used via the product activation unit; (e) if the first Ln+Rn set has been used, judging whether the first Ln+Rn set has not been licensed via the product activation unit yet; (f) if the first Ln+Rn set has not been licensed yet, judging whether a pairing of the first Ln+Rn set and the HWN (first Ln+Rn set+HWN) has not been used yet; (g) if the pairing of the first Ln+Rn set and the HWN (first Ln+Rn set+HWN) has not been used yet, determining that the pairing of the first Ln+Rn set and the HWN (first Ln+Rn set+HWN) is true; (h) downloading a first product number (first PN) composed of the pairing of the first Ln+Rn set and the HWN, from the product activation unit; and (i) installing the first PN in the EULA for licensing the OS to be used in the hardware device.

Furthermore, the method further comprises: (j) executing one of the application software installed in the hardware device for opening the EULA (End User License Agreement) of the one of the application software; (k) transmitting one of the Ln+Rn sets corresponding to the one of the application software, the hardware device's IP, and the first Ln+Rn set to the product activation unit; and, (l) judging whether the one of the second Ln+Rn sets has been used via the product activation unit.

In addition, the method further comprises: (m) if the one of the second Ln+Rn sets has been used, judging whether the one of the second Ln+Rn sets has not been licensed via the product activation unit yet; (n) if the one of the second Ln+Rn sets has not been licensed yet, judging whether a pairing of the one of the second Ln+Rn sets and the HWN (second Ln+Rn set+HWN) is true; (o) if the pairing of the one of the second Ln+Rn sets and the HWN (second Ln+Rn set+HWN) is true, determining that the pairing of the first Ln+Rn set and the one of the second Ln+Rn sets (first Ln+Rn set+second Ln+Rn set) is true; (p) downloading a second product number (second PN) composed of the first Ln+Rn set and the one of the second Ln+Rn sets (first Ln+Rn set+second Ln+Rn set), from the product activation unit; and (i) installing the second PN in the EULA for licensing the one of the application software to be used in the hardware device and under the OS.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a flow chart of a method of managing and auditing intellectual property according to a prior art; and

FIGS. 2A-2D is a flow chart of a method of managing and auditing intellectual property according to the present invention.

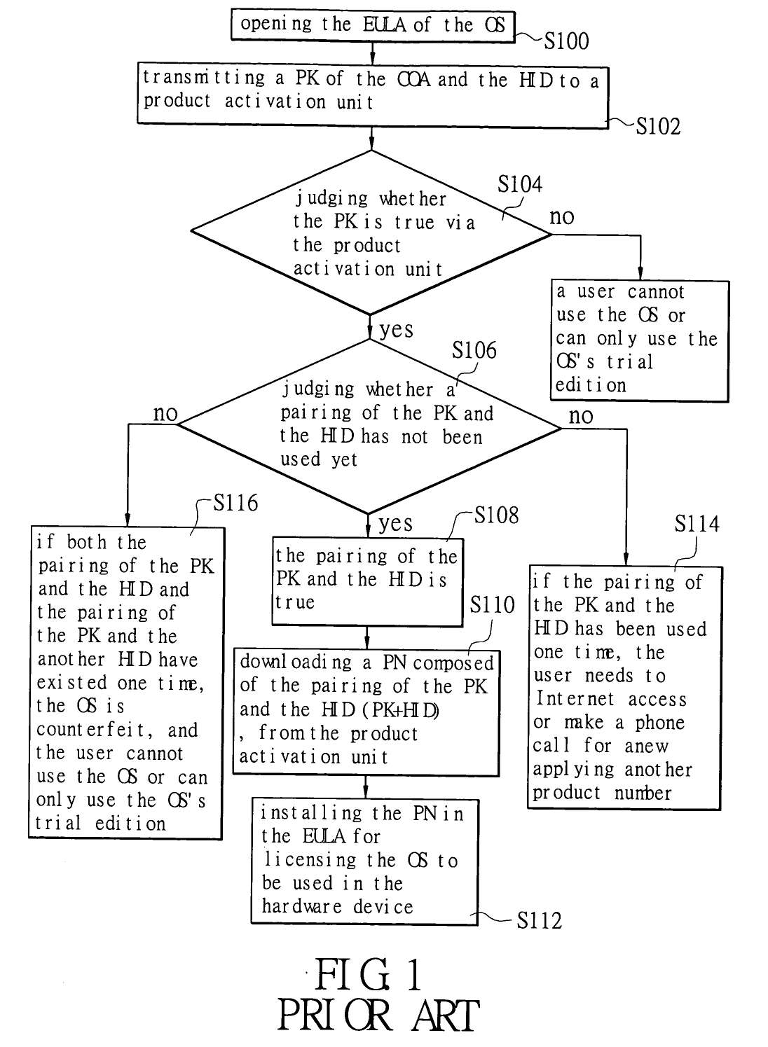

### DETAILED DESCRIPTION OF PREFERRED BEST MOLDS

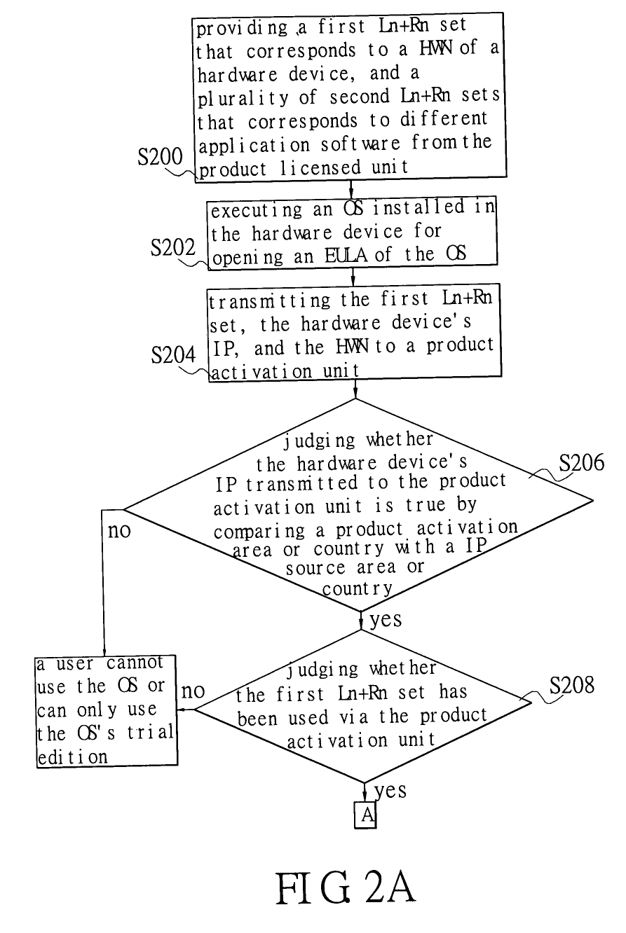

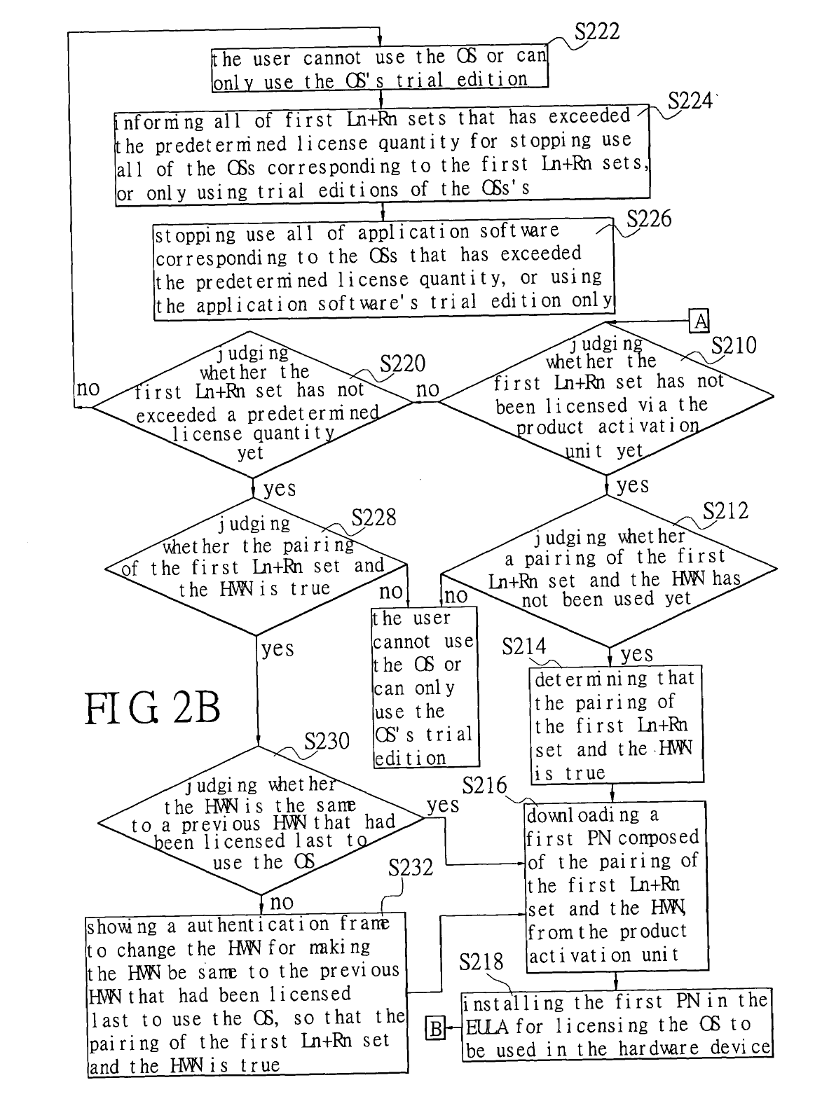

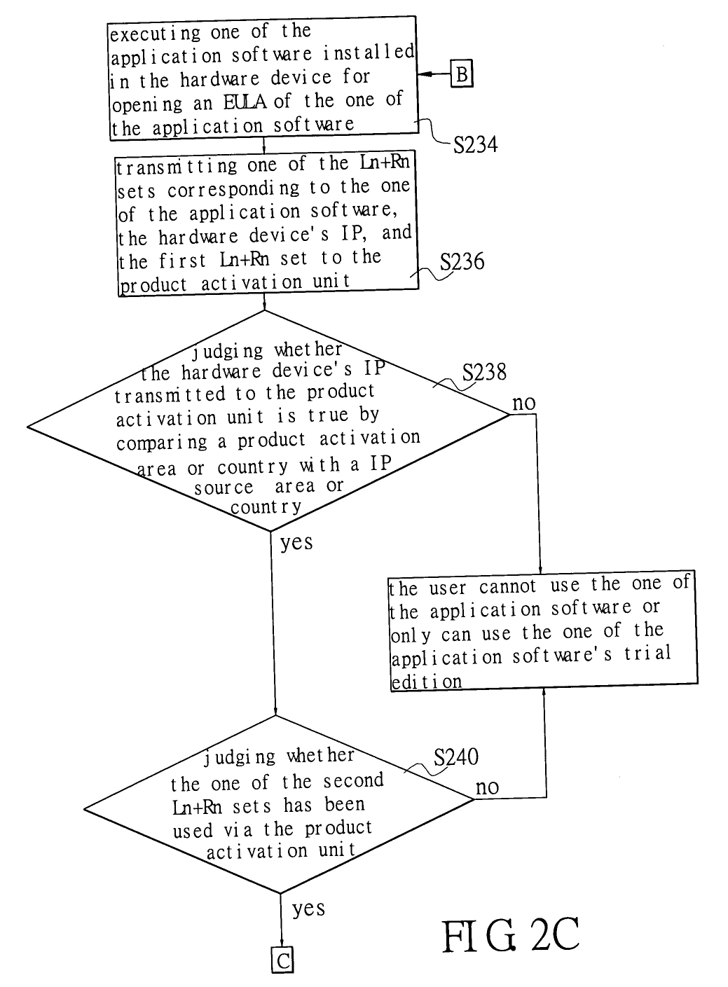

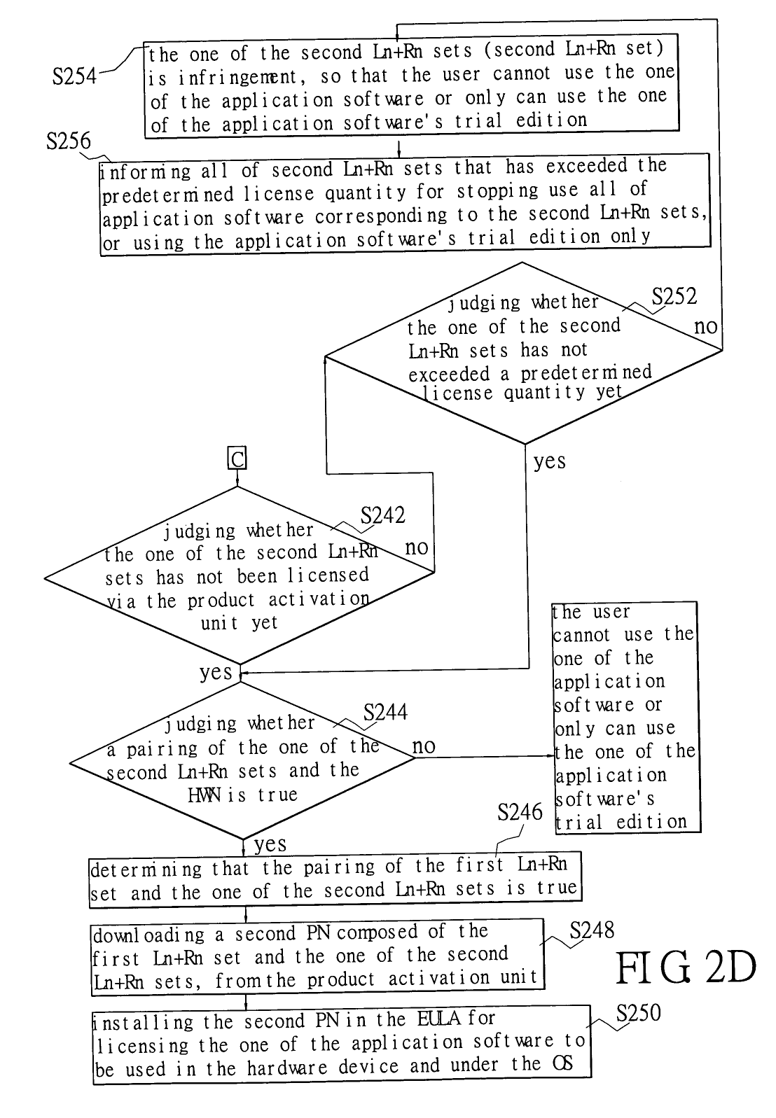

FIGS. 2A-2D show a flow chart of a method of managing and auditing intellectual property according to the present invention. The method comprises: firstly, providing a first license and royalty number set (first Ln+Rn set) that corresponds to a hardware number (HWN) of a hardware device, and a plurality of second license and royalty number sets (second Ln+Rn sets) that corresponds to different application software from the product licensed unit (S200). Moreover, the product licensed unit further comprises a first license code and royalty code set (first L code+R code) that corresponds to the first Ln+Rn set, and a plurality of second license code and royalty code set (second L code+R code) that corresponds to the second Ln+Rn sets, respectively. In addition, the HWN can be a hard disk, a motherboard or any other hardware devices.

Furthermore, the method further comprises: executing an OS (Operating System) installed in the hardware device for opening an EULA (End User License Agreement) of the OS (S202); transmitting the first Ln+Rn set, the hardware device's IP, and the HWN to a product activation unit (S204); judging whether the hardware device's IP transmitted to the product activation unit is true by comparing a product activation area or country with a IP source area or country (S206). If the hardware device's IP transmitted to the product activation unit is not true, a user cannot use the OS or can only use the OS's trial edition. If the hardware device's IP transmitted to the product activation unit is true, judging whether the first Ln+Rn set has been used via the product activation unit (S208).

In addition, after the step S208, the method further comprises: if the first Ln+Rn set has not been used yet, the first Ln+Rn set is false, so that the user cannot use the OS or can only use the OS's trial edition. If the first Ln+Rn set has been used, judging whether the first Ln+Rn set has not been licensed via the product activation unit yet (S210). If the first Ln+Rn set has not been licensed yet, judging whether a pairing of the first Ln+Rn set and the HWN (first Ln+Rn set+HWN) has not been used yet (S212).

Moreover, in the step S212, if the pairing of the first Ln+Rn set and the HWN (first Ln+Rn set+HWN) has been used, the pairing of the first Ln+Rn set and the HWN (first Ln+Rn set+HWN) is infringement, so that the user cannot use the OS or can only use the OS's trial edition. If the pairing of the first Ln+Rn set and the HWN (first Ln+Rn set+HWN) has not been used yet, determining that the pairing of the first Ln+Rn set and the HWN (first Ln+Rn set+HWN) is true (S214).

Furthermore, the method further comprises: downloading a first product number (first PN) composed of the pairing of the first Ln+Rn set and the HWN, from the product activation unit (S216), and then installing the first PN in the EULA for licensing the OS to be used in the hardware device (S218).

In addition, in the step S210, if the first Ln+Rn set has been licensed, judging whether the first Ln+Rn set has not exceeded a predetermined license quantity yet (S220). The predetermined license quantity can be two times or more than two times according to the user's need. If the first Ln+Rn set has exceeded the predetermined license quantity, the pairing of the first Ln+Rn set and the HWN (first Ln+Rn set+HWN) is infringement, so that the user cannot use the OS or can only use the OS's trial edition (S222).

Moreover, the method further comprises: informing all of first Ln+Rn sets that has exceeded the predetermined license quantity for stopping use all of the OSs corresponding to the first Ln+Rn sets, or only using trial editions of the OSs's (S224), and then stopping use all of application software corresponding to the OSs that has exceeded the predetermined license quantity, or using the application software's trial edition only (S226).

Furthermore, in the step S220, if the first Ln+Rn set has not exceeded the predetermined license quantity yet, judging whether the pairing of the first Ln+Rn set and the HWN (first Ln+Rn set+HWN) is true (S228). If the pairing of the first Ln+Rn set and the HWN (first Ln+Rn set+HWN) is not true, the pairing of the first Ln+Rn set and the HWN (first Ln+Rn set+HWN) is infringement, so that the user cannot use the OS or can only use the OS's trial edition. If the pairing of the first Ln+Rn set and the HWN (first Ln+Rn set+HWN) is true, judging whether the HWN is the same to a previous HWN that had been licensed last to use the OS (S230).

In addition, in the step S230, if the HWN is the same to the previous HWN that had been licensed last to use the OS, executing the step S216. If the HWN is not same to the previous HWN that had been licensed last to use the OS, showing a authentication frame to change the HWN for making the HWN be same to the previous HWN that had been licensed last to use the OS, so that the pairing of the first Ln+Rn set and the HWN (first Ln+Rn set+HWN) is true (S232), and then executing the step S216.

Moreover, after the step S218, the method further comprises: executing one of the application software installed in the hardware device for opening an EULA (End User License Agreement) of the one of the application software (S234), and then transmitting one of the Ln+Rn sets corresponding to the one of the application software, the hardware device's IP, and the first Ln+Rn set to the product activation unit (S236).

Furthermore, the method further comprises: judging whether the hardware device's IP transmitted to the product activation unit is true by comparing a product activation area or country with a IP source area or country (S238). If the hardware device's IP transmitted to the product activation unit is not true, the user cannot use the one of the application software or only can use the one of the application software's trial edition. If the hardware device's IP transmitted to the product activation unit is true, judging whether the one of the second Ln+Rn sets has been used via the product activation unit (S240).

In addition, in the step S240, if the one of the second Ln+Rn sets has not been used yet, the one of the second Ln+Rn sets is false, so that the user cannot use the one of the application software or only can use the one of the application software's trial edition. If the one of the second Ln+Rn sets has been used, judging whether the one of the second Ln+Rn sets has not been licensed via the product activation unit yet (S242).

Moreover, in the step S242, if the one of the second Ln+Rn sets has not been licensed yet, judging whether a pairing of the one of the second Ln+Rn sets and the HWN (second Ln+Rn set+HWN) is true (S244). If the pairing of the one of the second Ln+Rn sets and the HWN (second Ln+Rn set+HWN) is not true, the pairing of the first Ln+Rn set and the one of the second Ln+Rn sets (first Ln+Rn set+second Ln+Rn set) is infringement, so that the user cannot use the one of the application software or only can use the one of the application software's trial edition.

Furthermore, in the step S244, if the pairing of the one of the second Ln+Rn sets and the HWN (second Ln+Rn set+HWN) is true, determining that the pairing of the first Ln+Rn set and the one of the second Ln+Rn sets (first Ln+Rn set+second Ln+Rn set) is true (S246). In addition, the method further comprises: downloading a second product number (second PN) composed of the first Ln+Rn set and the one of the second Ln+Rn sets (first Ln+Rn set+second Ln+Rn set), from the product activation unit (S248), and then installing the second PN in the EULA for licensing the one of the application software to be used in the hardware device and under the OS (S250).

In addition, in the step S242, if the one of the second Ln+Rn sets has been licensed, judging whether the one of the second Ln+Rn sets has not exceeded a predetermined license quantity yet (S252). The predetermined license quantity can be two times or more than two times according to the user's need.

Moreover, in the step S252, if the one of the second Ln+Rn sets has exceeded the predetermined license quantity, the one of the second Ln+Rn sets (second Ln+Rn set) is infringement, so that the user cannot use the one of the application software or only can use the one of the application software's trial edition (S254). After the step S254, the method further comprises: informing all of second Ln+Rn sets that has exceeded the predetermined license quantity for stopping use all of application software corresponding to the second Ln+Rn sets, or using the application software's trial edition only (S256). In addition, if the one of the second Ln+Rn sets has not exceeded the predetermined license quantity yet, executing the step S244.

In conclusion, the method of managing and auditing intellectual property according to the present invention has following advantages:

(1) In the prior art, the user needs to key in about 25 letters and numbers corresponding to codes of the COA for the MPA, but the present invention only requires that the user keys in numbers.

(2) The method prevents similar HWN from being copied on a mass scale.

(3) When the same software is installed in different hardware systems, the product activation unit can automatically renew a product number. Hence, the method avoids users having to access an Internet site or make a phone call to apply for another product number.

(4) The method dynamically audits the status of counterfeit products or pirated version products.

(5) The method can search and collect information over Internet via IP by ISP (Internet Services Provider) Therefore, it is not necessary to resort to legal avenues, such as a physical search of a property which gives counterfeit software users a chance to wipe hard drives before evidence has been collected, to enforce the copyright holder's rights on software that is being used without permission.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of managing and auditing intellectual property, comprising:
(a) providing a first license and royalty number set (first Ln+Rn set) that corresponds to a hardware number (HWN) of a hardware device from a product licensed unit;
(b) executing an OS (Operating System) installed in the hardware device for opening an EULA (End User License Agreement) of the OS;
(c) transmitting the first Ln+Rn set, the hardware device's IP, and the HWN to a product activation unit;
(d) judging whether the first Ln+Rn set has been used via the product activation unit;
(e) if the first Ln+Rn set has been used, judging whether the first Ln+Rn set has not been licensed via the product activation unit yet;
(f) if the first Ln+Rn set has not been licensed yet, judging whether a pairing of the first Ln+Rn set and the HWN (first Ln+Rn set+HWN) has not been used yet;
(g) if the pairing of the first Ln+Rn set and the HWN (first Ln+Rn set+HWN) has not been used yet, determining that the pairing of the first Ln+Rn set and the HWN (first Ln+Rn set+HWN) is true;
(h) downloading a first product number (first PN) composed of the pairing of the first Ln+Rn set and the HWN, from the product activation unit; and
(i) installing the first PN in the EULA for licensing the OS to be used in the hardware device.

2. The method as claimed in claim 1, wherein the product licensed unit further comprises a first license code and royalty code set (first L code+R code) that corresponds to the first Ln+Rn set.

3. The method as claimed in claim 1, wherein the HWN is a hard disk or a motherboard.

4. The method as claimed in claim 1, between the step (c) and the step (d) further comprising:
judging whether the hardware device's IP transmitted to the product activation unit is true by comparing a product activation area or country with a IP source area or country; and
if the hardware device's IP transmitted to the product activation unit is true, executing the step (d).

5. The method as claimed in claim 4, wherein if the hardware device's IP transmitted to the product activation unit is not true, a user cannot use the OS or can only use the OS's trial edition.

6. The method as claimed in claim 1, wherein if the first Ln+Rn set has not been used yet, the first Ln+Rn set is false, so that a user cannot use the OS or can only use the OS's trial edition.

7. The method as claimed in claim 1, wherein if the first Ln+Rn set has been licensed, the method further comprises:
judging whether the first Ln+Rn set has not exceeded a predetermined license quantity yet;
if the first Ln+Rn set has not exceeded the predetermined license quantity yet, judging whether the pairing of the first Ln+Rn set and the HWN (first Ln+Rn set+HWN) is true;
if the pairing of the first Ln+Rn set and the HWN (first Ln+Rn set+HWN) is true, judging whether the HWN is the same to a previous HWN that had been licensed last to use the OS; and
if the HWN is the same to the previous HWN that had been licensed last to use the OS, executing the step (h).

8. The method as claimed in claim 7, wherein the predetermined license quantity is a plurality of times.

9. The method as claimed in claim 7, wherein if the first Ln+Rn set has exceeded the predetermined license quantity, the pairing of the first Ln+Rn set and the HWN (first Ln+Rn set+HWN) is infringement, so that a user cannot use the OS or can only use the OS's trial edition.

10. The method as claimed in claim 9, further comprising informing all of first Ln+Rn sets that has exceeded the predetermined license quantity for stopping use all of the OSs corresponding to the first Ln+Rn sets, or only using trial editions of the OSs's.

11. The method as claimed in claim 9, further comprising stopping use all of application software corresponding to the OSs that has exceeded the predetermined license quantity, or using the application software's trial edition only.

12. The method as claimed in claim 7, wherein if the pairing of the first Ln+Rn set and the HWN (first Ln+Rn set+HWN) is not true, the pairing of the first Ln+Rn set and the HWN (first Ln+Rn set+HWN) is infringement, so that a user cannot use the OS or can only use the OS's trial edition.

13. The method as claimed in claim 7, wherein if the HWN is not same to the previous HWN that had been licensed last to use the OS, the method further comprising:
showing a authentication frame to change the HWN for making the HWN be same to the previous HWN that had been licensed last to use the OS, so that the pairing of the first Ln+Rn set and the HWN (first Ln+Rn set+HWN) is true; and
executing the step (h).

14. The method as claimed in claim 1, wherein if the pairing of the first Ln+Rn set and the HWN (first Ln+Rn set+HWN) has been used, the pairing of the first Ln+Rn set and the HWN (first Ln+Rn set+HWN) is infringement, so that a user cannot use the OS or can only use the OS's trial edition.

15. The method as claimed in claim 1, wherein the step (a) further comprising: providing a plurality of second license and royalty number sets (second Ln+Rn sets) that corresponds to different application software from the product licensed unit.

16. The method as claimed in claim 15, after the step (i) further comprising:
(j) executing one of the application software installed in the hardware device for opening an EULA (End User License Agreement) of the one of the application software;
(k) transmitting one of the Ln+Rn sets corresponding to the one of the application software, the hardware device's IP, and the first Ln+Rn set to the product activation unit;
(l) judging whether the one of the second Ln+Rn sets has been used via the product activation unit;
(m) if the one of the second Ln+Rn sets has been used, judging whether the one of the second Ln+Rn sets has not been licensed via the product activation unit yet;
(n) if the one of the second Ln+Rn sets has not been licensed yet, judging whether a pairing of the one of the second Ln+Rn sets and the HWN (second Ln+Rn set+HWN) is true;
(o) if the pairing of the one of the second Ln+Rn sets and the HWN (second Ln+Rn set+HWN) is true, determining that the pairing of the first Ln+Rn set and the one of the second Ln+Rn sets (first Ln+Rn set+second Ln+Rn set) is true;
(p) downloading a second product number (second PN) composed of the first Ln+Rn set and the one of the second Ln+Rn sets (first Ln+Rn set+second Ln+Rn set), from the product activation unit; and
(i) installing the second PN in the EULA for licensing the one of the application software to be used in the hardware device and under the OS.

17. The method as claimed in claim 15, wherein the product licensed unit further comprises a plurality of second license code and royalty code set (second L code+R code) that corresponds to the second Ln+Rn sets, respectively.

18. The method as claimed in claim 16, between the step (k) and the step (l) further comprising:
judging whether the hardware device's IP transmitted to the product activation unit is true by comparing a product activation area or country with a IP source area or country; and
if the hardware device's IP transmitted to the product activation unit is true, executing the step (l).

19. The method as claimed in claim 18, wherein if the hardware device's IP transmitted to the product activation unit is not true, a user cannot use the one of the application software or only can use the one of the application software's trial edition.

20. The method as claimed in claim 16, wherein if the one of the second Ln+Rn sets has not been used yet, the one of the second Ln+Rn sets is false, so that a user cannot use the one of the application software or only can use the one of the application software's trial edition.

21. The method as claimed in claim 16, wherein if the one of the second Ln+Rn sets has been licensed, the method further comprises:
judging whether the one of the second Ln+Rn sets has not exceeded a predetermined license quantity yet; and
if the one of the second Ln+Rn sets has not exceeded the predetermined license quantity yet, executing the step (n).

22. The method as claimed in claim 21, wherein the predetermined license quantity is a plurality of times.

23. The method as claimed in claim 16, wherein if the one of the second Ln+Rn sets has exceeded the predetermined license quantity, the one of the second Ln+Rn sets (second Ln+Rn set) is infringement, so that a user cannot use the one of the application software or only can use the one of the application software's trial edition.

24. The method as claimed in claim 23, further comprising informing all of second Ln+Rn sets that has exceeded the predetermined license quantity for stopping use all of application software corresponding to the second Ln+Rn sets, or using the application software's trial edition only.

25. The method as claimed in claim 16, wherein if the pairing of the one of the second Ln+Rn sets and the HWN (second Ln+Rn set+HWN) is not true, the pairing of the first Ln+Rn set and the one of the second Ln+Rn sets (first Ln+Rn set+second Ln+Rn set) is infringement, so that a user cannot use the one of the application software or only can use the one of the application software's trial edition.
